(19) United States
(12) Patent Application Publication
(10) Pub. No.: US 2010/0032020 A1
(43) Pub. Date: Feb. 11, 2010

(54) Method and Apparatus for Injecting a Jet of Fluid with a Variable Direction and/or Opening

(75) Inventors: Bernard Labegorre, Paris (FR); Nicolas Docquier, Philadelphia, PA (US); Bernard Zamuner, Garches (FR); Thomas Lederlin, Toulouse (FR); Thierry Poinsot, Plaisance Du Touch (FR); Vincent Faivre, Toulouse (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/307,732

(22) PCT Filed: Jul. 5, 2007
(86) PCT No.: PCT/FR07/51597

§ 371 Date: Oct. 21, 2009

(30) Foreign Application Priority Data
Jul. 6, 2006 (FR) 06 52845

(51) Int. Cl. A23G 9/28

(52) U.S. Cl. 137/1; 137/602

(57) ABSTRACT

The invention relates to an apparatus for injecting at least one jet of fluid, in which the direction and/or opening of at least one of the jets may be variable, comprising means of injecting at least one main fluid jet, means for injecting at least one secondary fluid jet, and means for causing at least one main fluid jet to interact with at least one secondary fluid jet and producing a fluid jet resulting from this interaction whose direction and/or opening are variable; as well as the associated method; and the uses of these.

The present invention relates to an injection apparatus making it possible to vary the direction and/or the aperture of a fluid jet, for example a jet of air or of oxygen, of nitrogen, of gaseous fuel or else of liquid or solid fuel with a gas, said fluid jet resulting from an interaction between a primary fluid jet and at least one secondary fluid jet. The invention relates notably to such an injection gun.

The invention also relates to the use of said injection apparatus to vary the direction and/or the aperture of a fluid jet, for example in contact with a surface and notably above a load. It also concerns a method of injection in which the user varies the direction and/or the aperture of at least one fluid jet.

### BACKGROUND OF THE INVENTION

It is known practice from EP-A-0545357 to change the direction of an atomized jet by means of a control gas flow: (1) by bringing the material to be atomized across an atomization passageway having a portion of constant cross section and a flared downstream portion, (2) by atomizing the material by means of an annular jet of atomization gas, (3) by placing in contact the jet of atomization gas and a flow of control gas so as to create a pressure differential through the jet of atomization gas and (4) by using this pressure differential to vary the direction of the atomized jet.

However, this method, which is limited to atomized jets, allows only a fairly slight change in the direction of the jet.

### OBJECT OF THE INVENTION

The object of the invention is to allow a great variation in the direction and/or the aperture of a fluid jet without having to interrupt the operation of the injector. A further object of the invention is to allow such a variation with an optimized robust apparatus.

### BRIEF DESCRIPTION OF THE INVENTION

The invention proposes to control a primary fluid jet (also called a main jet) by interaction with at least one other fluid jet (called a secondary or actuator jet), the interaction between the jets occurring inside the passageway delivering the primary jet (a pipe with a constant section or a variable section, etc.) before said primary jet emerges from said passageway, optionally close to the location where the primary jet emerges from said passageway (hereinafter called the “main outlet aperture”).

Therefore the invention relates to an apparatus for the injection of a fluid jet resulting from an interaction between a primary jet and at least one secondary jet, said apparatus making it possible to vary the direction and/or the aperture of said resultant jet.

The injection apparatus comprises a passageway for bringing the primary jet to the main outlet aperture. It also comprises at least one secondary pipe for the injection of a secondary jet, this secondary pipe leading into the passageway of the primary jet via a secondary aperture situated upstream of the main aperture. The arrangement between the passageway bringing the primary jet and the secondary pipe defines the point of interaction between the primary jet and the secondary jet coming out of this secondary pipe (hereinafter called the corresponding secondary jet).

The apparatus comprises at least one secondary pipe positioned relative to the passageway so that, at the point of interaction between the corresponding secondary jet and the primary jet, the angle θ between the axis of the corresponding secondary jet and the plane perpendicular to the axis of the primary jet is greater than or equal to 0° and less than 90°, preferably from 0° to 80° and yet more preferably from 0° to 45°.

Also according to the invention, the secondary aperture(s) that are situated upstream of the main outlet aperture are spaced from said main aperture by a distance L that is less than or equal to ten times the square root of the section s of the main aperture. The distance L is preferably less than or equal to 5 times this square root and yet more preferably less than or equal to 3 times this square root.

The at least one secondary jet interacts with the primary jet so as to generate a resultant jet.

From the “Proceedings of FEDSM'02 Joint US ASME-European Fluid Engineering Division Summer Meeting of Jul. 14-18, 2002” and from the article “Experimental and numerical investigations of jet active control for combustion applications” by V. Faivre and Th. Poinsot, Journal of Turbulence, Volume 5, No. 1, March 2004, p. 25, it is known practice to use a specific configuration of four secondary jets around a main jet to stabilize a flame thanks to the interaction between the secondary jets and the primary jet. A wider angle of dispersion is reported.

According to the invention, the apparatus is furnished with means for controlling the force of the at least one secondary jet.

The invention therefore makes it possible to vary the direction and/or the aperture of the resultant jet by changing the force of at least one secondary jet with said means.

Preferably, the means for controlling the force of the at least one secondary jet are means making it possible to control the ratio between the force of the secondary jet and the force of the primary jet.

The invention therefore makes it possible to produce a large variation in the direction and/or aperture of a jet without making use of mechanical means, potential sources of malfunction, in particular in hostile environments, such as high-temperature fire chambers.

The control means notably allow an active or dynamic control of the force of at least one secondary jet, that is to say they make it possible to vary the force or forces without interrupting the injection of the main jet. The apparatus according to the invention therefore allows a dynamic variation in the direction and/or the aperture of the resultant jet.

Preferably, the number of secondary jets interacting with the primary jet to obtain the desired effect on the resultant jet will be minimized so as to limit the complexity and the cost of manufacture of the apparatus but also the complexity and the cost of the system for supplying and regulating the flow rates of the fluids if the secondary jets are controlled in an independent manner. For example, a mono-directional effect may be obtained with a single secondary jet.

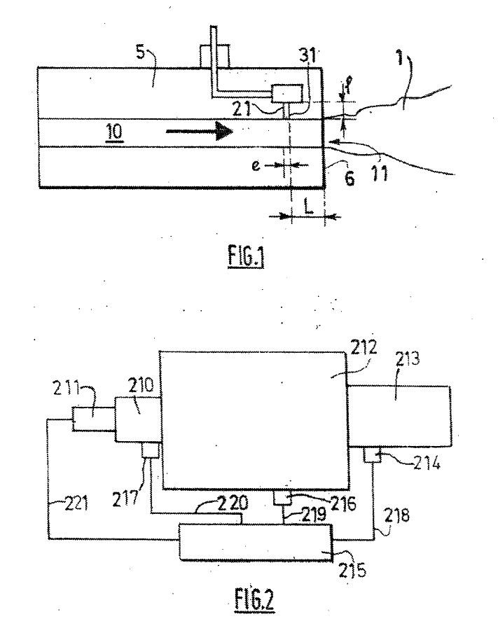

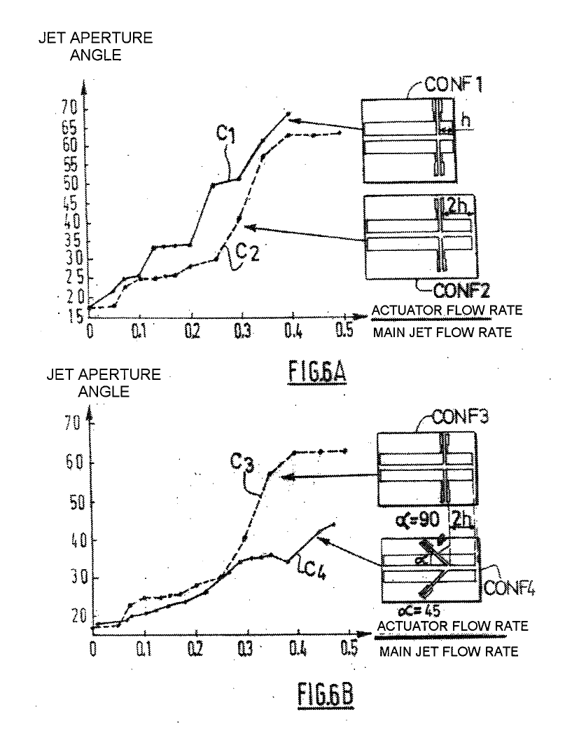

Amongst the terms used in the present description, some are worthy of being more precisely defined in the context of the invention in order to better delimit their significance:
the direction of a jet is defined as being a unitary vector at right angles to the section of passageway of the fluid and oriented in the direction of the flow, that is to say from upstream to downstream.
the “thickness e” means the dimension of the secondary pipe in the direction of flow of the primary jet (in the direction of the arrow in FIG. 1). In the particular case of this FIG. 1, e therefore represents the diameter of the secondary pipe 21 at the secondary aperture 31 since this secondary pipe 21 is cylindrical in this example.
the “aperture” of a jet means, for a jet emerging from a cylindrical passageway such as 10 in FIG. 1, the angle between the longitudinal axis of the passageway and the generatrix at the surface of the jet leaving the passageway. In the absence of interaction with a secondary jet, the generatrix is inclined by 15° approximately relative to this axis, this inclination being capable of reaching 70° and more according to the invention (see FIG. 6A). By extension, “aperture” will mean the angle between the direction of flow in the passageway, when the latter has no circular section, and the generatrix.

### DETAILED DESCRIPTION OF THE INVENTION

The various features of the embodiments of the apparatus according to the invention and its use will appear more clearly from the following detailed description, reference being made to the figures which represent, in a schematic manner, exemplary embodiments given as being nonlimiting and more particularly:

FIG. 1: diagram of an apparatus according to the invention for the control of a flow by interaction of jets.

FIG. 2: regulation of an apparatus according to the invention mounted on a fire chamber.

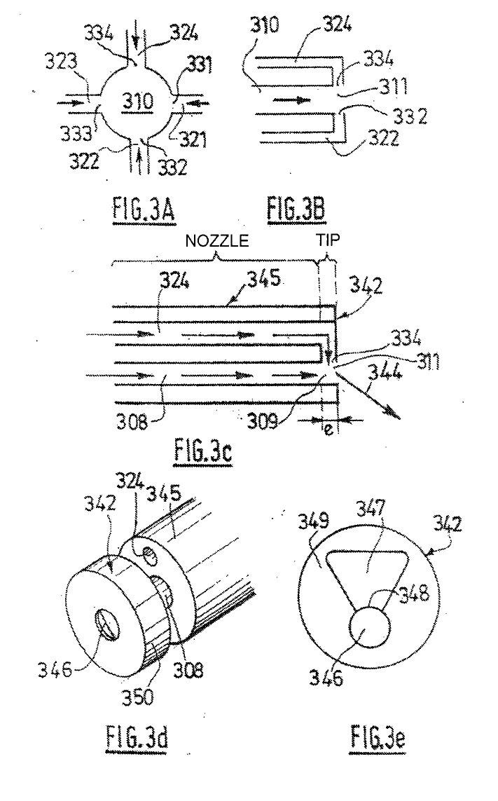

FIGS. 3A and B: apparatus for the control of the direction of the resultant jet, FIG. 3A being a cross section and FIG. 3B a longitudinal section of an apparatus comprising four secondary jets placed respectively at 90° from one another and coming into incidence perpendicular to the direction of the primary jet.

FIGS. 3C, D and E: use of a tip to convert a nozzle with parallel primary and secondary jets into an apparatus according to the invention.

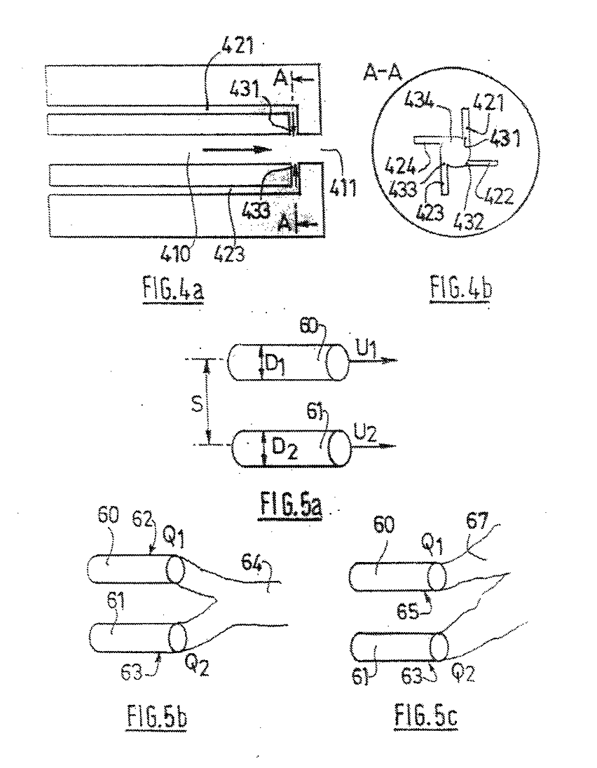

FIGS. 4A and B: longitudinal and cross section of an apparatus allowing the control of the aperture of a resultant jet.

FIG. 5: use of items of apparatus to vary the direction of two (resultant) jets.

FIGS. 6A and B: variant embodiments of the control of the aperture of a jet.

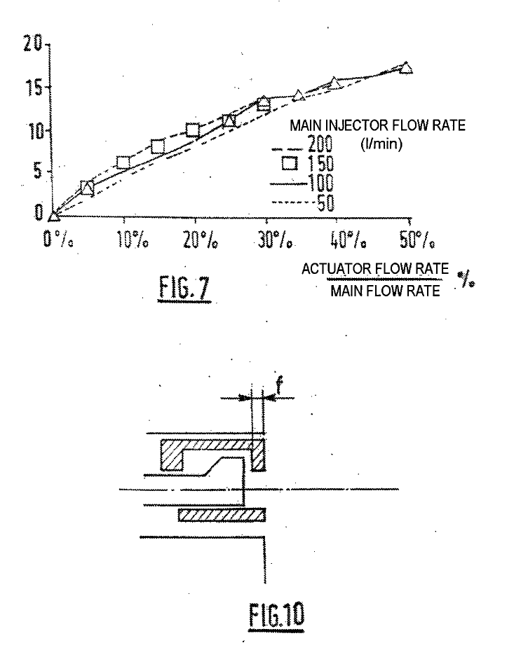

FIG. 7: graph illustrating the effect of the primary and secondary flow rates on the deviation of the resultant jet.

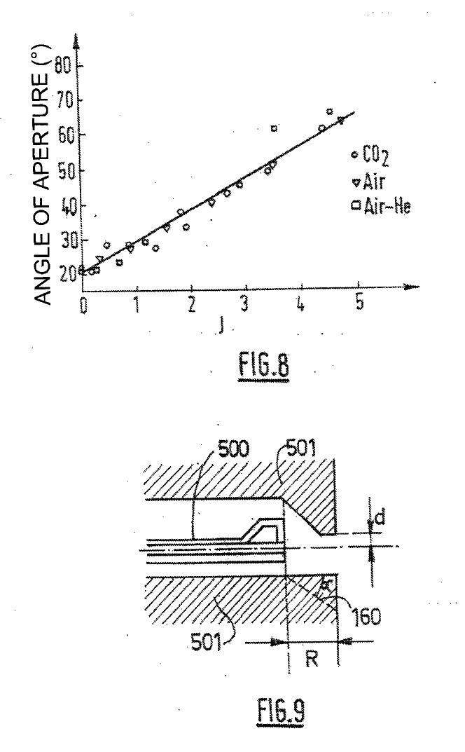

FIG. 8: graph illustrating the effect of the ratio of forces of the jets on the aperture of the resultant jet.

FIG. 9: protection of the end of the apparatus by a refractory port.

FIG. 10: protection of the end of the apparatus by a sleeve.

In the following text, the same reference numbers are used, on the one hand, to designate the primary jet and the passageway in which it flows and, on the other hand, to designate the secondary jet or actuator and the corresponding secondary pipe in which this secondary jet flows.

FIG. 1 represents a diagram of the method of controlling a jet according to the invention.

The primary jet to be controlled is brought via the passageway 10 and comes to interact with the secondary jet originating from the secondary pipe 21 so as to create a resultant jet 1 with a direction and/or aperture that are different from the jet coming out of the main outlet aperture 11 in the absence of a secondary jet.

The apparatus comprises a passageway 10 which makes it possible to bring the primary jet to a main outlet aperture 11.

At least one secondary pipe 21 for the injection of a secondary jet leads to the passageway 10 via a secondary aperture 31. This secondary pipe 21 is positioned relative to the passageway 10 so that, at the point of interaction between the corresponding secondary jet and the primary jet, the angle θ between the axis of the secondary jet 21 and the plane perpendicular to the axis of the primary jet 10 is greater than or equal to 0° and less than 90°. (θ=0° in FIG. 1). The secondary aperture 31 is spaced from the main aperture 11 by a distance L, L being less than or equal to 10 H √s (s=section of the main aperture 11).

The distance L makes it possible to influence the impact of the secondary jets on the primary jet with identical respective forces. For example, to maximize the directional effect, the user will attempt to minimize this distance.

As a general rule, L is less than or equal to 20 cm, more preferably less than or equal to 10 cm.

The apparatus comprises means for controlling the force of the secondary jets. These means may usefully be chosen amongst the devices for mass flow-rate control, for pressure loss control, for passageway section control, but also the devices for temperature control, control of the chemical composition of the fluid or for control of pressure.

These means are preferably means making it possible to control the ratio between the force of the secondary jet and the force of the primary jet.

The control means make it possible to activate and deactivate one or more secondary jets (flow or absence of flow of the secondary jet concerned) in order to vary dynamically the direction and/or the aperture of the resultant jet.

The control means preferably make it possible also dynamically to increase and reduce the force (non zero) of one or more secondary jets or to increase and reduce the ratio between the force of a secondary jet and the force of the primary jet.

The apparatus may comprise a block of material 5, such as a block of refractory material, in which at least a portion of the passageway 10 is situated, the main outlet aperture 11 being situated on one of the faces or surfaces of the block: the front face 6.

In FIG. 1, the secondary jet is carried by a secondary pipe 21 which passes through the block 5, this secondary jet preferably emerging substantially perpendicularly to the primary jet.

The interaction between the primary jet and the secondary jet takes place at a distance L from the front face 6 of the block from which the passageway 10 of the primary jet emerges, this distance L being able to vary as indicated above.

According to one embodiment making it possible to vary the direction of the resultant fluid jet illustrated in FIGS. 3A and 3B, the apparatus comprises at least one secondary pipe 321, 322, 323 and 324 which is positioned relative to the passageway 310 of the primary jet so that, at the corresponding secondary aperture 331, 332, 333 and 334 (that is to say the secondary aperture via which the secondary pipe in question leads to the passageway), the axis of the primary jet and the axis of the corresponding secondary jet are secant or quasi-secant.

Such an arrangement between the passageway and the secondary pipe makes it possible to change the angle between the axis of the resultant fluid jet (downstream of the corresponding secondary aperture) and the axis of the primary jet upstream of this secondary aperture by changing the force of at least one corresponding secondary jet.

If, in the absence of an actuator jet, the jet originating from the main outlet aperture 311 flows perpendicularly to the plane of FIG. 3A, the injection of a jet via the secondary pipe 323 allows a deviation of the resultant jet to the right in FIG. 3A, that is to say in the same direction as the direction of flow of the jet originating from 323. If simultaneously there is an injection of a secondary jet via the secondary pipe 324, depending on the quantities of the relative movement of the jets originating from 323 and 324, it will be possible to obtain a resultant jet that is deviated in a direction (projected in the plane of FIG. 3A) which may vary continuously between the directions of the jets originating from 323 and 324 (rightward and downward in FIG. 3A).

Preferably, the apparatus comprises at least two secondary pipes that are positioned relative to the passageway 310 so that, on the one hand, the two corresponding secondary apertures are situated on one and the same cross section of the passageway 310 and that, on the other hand, at these two secondary apertures, the axes of the corresponding secondary jets are secant or quasi-secant with the axis of the primary jet. In this case, the two corresponding secondary apertures may, usefully, be situated on either side of the axis of the primary jet (on the right and on the left for the apertures 331 and 333; below and above for the apertures 332 and 334), the two secondary apertures and the axis of the primary jet preferably being situated in one and the same plane (horizontal for the apertures 331 and 333; vertical for the apertures 332 and 334).

According to another useful configuration, at the two corresponding secondary apertures, the plane defined by the axis of the primary jet and one of the two corresponding secondary apertures is perpendicular to the plane defined by the axis of the primary jet and the other of the two corresponding apertures. For example, the horizontal plane defined by the axis of the passageway 310 and the secondary aperture 331 is perpendicular to the vertical plane defined by this axis and the secondary aperture 332.

It is also possible to combine these two forms of execution. In this case, as illustrated in FIGS. 3A and 3B, the apparatus comprises at least four secondary pipes 321, 322, 323 and 324 which are positioned relative to the passageway 310 such that:
(1) the four corresponding secondary apertures 331, 332, 333, 334 are situated on one and the same cross section of the passageway 310, and
(2) two of these corresponding secondary apertures 331 and 333 define a first plane with the axis of the primary jet and are situated on either side of this axis, the other two secondary apertures 332 and 334 defining a second plane with the axis of the primary jet, the first plane preferably being perpendicular to the second plane.

This arrangement makes it possible to vary the angle between the axis of the resultant fluid jet and the axis of the primary jet on the first and on the second plane (for example on the horizontal plane and on the vertical plane) and as required to one or other of the two secondary apertures situated in each plane (for example, to the left and to the right on the horizontal plane, and upward and downward on the vertical plane) and, as explained above, to any intermediate direction.

At the four corresponding secondary apertures 331 to 334, the axes of the four corresponding secondary jets are preferably in one and the same plane perpendicular to the axis of the primary jet 310.

The invention also makes it possible to produce an interaction between the primary jet and one or more secondary jets so as to generate, maintain or strengthen a rotation of the resultant fluid jet about its axis. Such an interaction makes it possible to vary the aperture of the resultant jet.

As illustrated in FIGS. 4A and 4B, the apparatus may be furnished with at least one secondary pipe 421 to 424 which is positioned relative to the passageway 410 of the primary jet so that, at the corresponding secondary aperture 431 to 434, the axis of the corresponding secondary jet 421 to 424 is not coplanar or in substance coplanar with the axis of the primary jet 410, this at least one secondary pipe 421 to 424 preferably emerging tangentially into the passageway 410 of the primary jet. In this manner, the interaction between the primary jet and the secondary jet confers a rotary force on the primary jet.

The apparatus may usefully comprise two secondary pipes 421 and 422 positioned relative to the passageway 410 of the primary jet so that, at the two corresponding secondary apertures 431, 432, the axes of the two corresponding secondary jets 421 and 422 are not coplanar with the axis of the primary jet 410, the two secondary jets being oriented in one and the same direction of rotation about the axis of the primary jet. The two secondary jets therefore contribute to the force of rotation conferred on the primary jet.

The two secondary apertures are advantageously situated on one and the same cross section of the passageway 410—in one and the same plane perpendicular to the axis of the primary jet. They may be situated on either side of the axis of the primary jet (apertures 421 and 423 or 422 and 424). They may also be situated so that the plane defined by the axis of the primary jet and one of the two secondary apertures 421 is perpendicular to the plane defined by the axis of the primary jet and the other of the two secondary apertures 422.

According to one form of execution, the apparatus comprises at least four secondary pipes 421 to 424 which are positioned relative to the passageway 410 of the primary jet so that, at the corresponding secondary apertures 431 to 434, the axes of the corresponding secondary jets are not in substance coplanar with the axis of the primary jet. Two of the corresponding secondary apertures 431 and 433 are in substance coplanar with the axis of the primary jet 410 on a first plane and situated on either side of the axis of the primary jet. The other two corresponding secondary apertures 432 and 434 are in substance coplanar with the axis of the primary jet 410 on a second plane and also situated on either side of the primary axis, the four corresponding secondary jets being oriented in one and the same direction of rotation about the axis of the primary jet. The first and the second plane may notably be perpendicular relative to one another. It is also preferable that the four corresponding secondary apertures are on one and the same cross section of the passageway 410.

To confer a rotary force on the primary jet and therefore to change the aperture of the resultant jet, the user will ensure preferably that at the secondary aperture where the primary jet and the corresponding secondary jet interact, on the one hand, the axis of the secondary jet belongs to the plane perpendicular in this location to the axis of the primary jet, and, on the other hand, the angle between the axis of the secondary jet and the tangent to the secondary aperture (or more exactly to the imaginary surface of the passageway of the primary jet at the secondary aperture) in this plane is between 0 and 90°, preferably between 0 and 45°.

FIGS. 4a and b show an exemplary embodiment with secondary jets for the control of the aperture of a resultant jet. The primary jet (which flows from left to right in the passageway 410 in FIG. 4a) meets the secondary jets originating from the secondary pipes 421, 422, 423 and 424 (represented in FIG. 4b which is a cross section on the plane AA of FIG. 4a). These secondary jets impact the primary jet in a manner tangential to the passageway 410, therefore making it possible, depending on the forces of these various jets, to “open” more or less the resultant jet. This opening effect is essentially due to the fact that the secondary jets and the primary jet have axes which do not intersect, although the jets have a physical interaction with one another. This causes the resultant jet to rotate on its axis.

It is also possible to combine in a single apparatus the embodiment making it possible to vary the direction of the resultant jet according to any one of the application methods described above with any one of the embodiments described above making it possible to generate, maintain or strengthen a rotation of the resultant jet and therefore to vary its aperture.

To obtain both a directional and rotational effect, the user will therefore combine the teaching of the above paragraphs. To obtain a dynamic variation of the directional and rotational effects, the user may for example provide several injection systems of secondary jets. By providing separate secondary pipes with means for regulating the force of the secondary jet, such as supply valves, it is therefore possible to change, in a continuous or discontinuous manner, the shape and the direction of the resultant jet simply by actuating said regulation means (valves).

To allow the secondary jet to act as effectively as possible on the primary jet, the actuator jet must be injected substantially perpendicularly to the direction of the main jet.

For an optimized operation, the apparatus according to the invention may comprise at least one secondary pipe 21 positioned relative to the passageway 10 of the primary jet so that, at the corresponding secondary aperture 31, this pipe has a thickness e and a height l, such that l≧0.5 H e and preferably: 0.5 H e≦l≦5.0 H e (see FIG. 1). A minimal height greater than or equal to 0.5 H e makes it possible to achieve an optimized interaction between the corresponding secondary jet and the primary jet.

For example, in order in practice to achieve a secondary jet such that, at the point of interaction between this secondary jet and the primary jet, the angle θ between the axis of the secondary jet and the plane perpendicular to the axis of the primary jet is 0°, it would be preferable that, before the corresponding secondary aperture, the secondary pipe has a direction substantially perpendicular to the axis of the primary jet for a length l which will preferably be between 0.5 and 5 times the thickness e (the dimension in the direction of flow of the main fluid) of said duct (e is the diameter of the duct when the latter is cylindrical). Naturally, it is also possible for this length l to be greater than 5e, but this does not have any additional effect of significant impact of the secondary jet on the primary jet.

The passageway of the primary jet may consist, in totality or for at least a portion, in a primary pipe for the injection of the primary jet. This primary pipe leads to a primary aperture 309 (see FIG. 3c). This primary aperture may coincide with the main outlet aperture of the passageway.

When, as illustrated in FIGS. 3c, d and e, the primary pipe 308 terminates before the main outlet aperture 311, the primary aperture 309 is positioned upstream of the main aperture 311. In this case, at least one secondary aperture 334 may be situated between the primary aperture 309 of the primary pipe 308 and the main aperture 311 of the passageway.

FIG. 3c represents a variant embodiment similar to FIG. 3B; however, with an embodiment in which there are two parallel channels (primary pipe 308 and secondary pipe 324) in a nozzle 345, the two channels 308 and 324 leading onto the front face of the nozzle. On this front face, a tip 342 is fitted which makes it possible to orient the secondary jet of the secondary pipe 324 toward the primary jet coming out of the primary pipe 308, and more particularly perpendicularly or substantially perpendicularly to the primary jet, so as to obtain a resultant jet, for example in the direction indicated by the arrow 344 in FIG. 3c. (The direction 344 of the resultant jet will depend on the ratio of the forces of the primary and secondary jets.) By varying the force of the secondary jet with the aid of the control means, it is therefore possible to obtain a variable resultant jet direction making it possible to sweep a whole surface with the resultant jet. FIG. 3d is an exploded view of the nozzle 345 to which the tip 342 is attached (by means not shown in this figure), in the form, in this instance, of a hollow lateral cylindrical portion 350 which will come to rest on the end of the nozzle 345, while the aperture 346 in the tip is positioned where the primary pipe 308 emerges.

FIG. 3e represents the bottom (inside) of this tip 342 whose inner face 349 comprises a cavity 347 in which the secondary jet originating from the secondary pipe 324 will be distributed and then encounter substantially perpendicularly the primary jet originating from the primary pipe 308 by means of the slot 348 above the main outlet aperture 346. The resultant jet 344 (FIG. 3c) coming out of this aperture 346 will therefore be diverted downward (relative to FIGS. 3c, d and e).

It should be noted that the possibility of using a tip to confer the desired orientation on one or more secondary jets before their respective points of interaction with the primary jet is not limited to the secondary jets oriented so as to vary the direction of the resultant jet, but also applies to the secondary jets described above making it possible to vary aperture of the resultant jet.

For the optimal operation of the apparatus according to the invention, the passageway of the primary jet will have, at the at least one secondary aperture, an unobstructed, or at least in substance unobstructed, fluid passageway in the extension of the at least one corresponding secondary pipe, in order to allow an effective interaction between the at least one corresponding secondary jet and the primary jet. Typically, the cross section of the passageway of the primary jet will define an unobstructed or at least in substance unobstructed fluid passageway at the at least one secondary aperture.

The invention also relates to the use of the apparatus in order to vary the direction and/or the aperture of a fluid jet, for example of a fluid jet comprising oxygen and/or argon and/or carbon dioxide and/or hydrogen. Another possibility is the use of the apparatus in order to vary the direction and/or the aperture of a fluid jet comprising a fuel and/or an oxidant injected into a combustion zone.

The resultant jet of which the user thereby varies the direction and/or the aperture may be a supercritical fluid jet.

The jet is typically a gaseous jet; however, the gaseous jet may comprise an atomized liquid and/or solid particles, such as ground solids.

The invention also relates to an injection method in which the apparatus according to the invention is used to inject a fluid jet resulting from an interaction between a primary jet and at least one secondary jet and in which the user varies dynamically the direction and/or the aperture of the resultant jet by varying the force of at least one secondary jet or else by varying the ratio between the force of at least one secondary jet and the force of the primary jet.

Therefore the invention relates to a method for controlling dynamically or actively the performance of a fluid injection system with the aid of one or more secondary jets (also called actuator jets), impacting the primary jet in order to change the flow of the primary jet and to produce a resultant jet whose direction and/or aperture may be modified according to the characteristics (notably direction and quantity of movement) of the primary and/or secondary jets. This method may be used to regulate in a closed loop or in an open loop the performance of a combustion system or more generally of industrial methods using injections of fluid jets (liquid, gaseous or solid dispersion).

FIG. 2 represents a method for regulating the performance of an apparatus 210 according to the invention, such as an injection gun, mounted on a fire chamber 212.

The sensors 214, 216 and 217 measure respectively the magnitudes characterizing the combustion products, the operating conditions of the combustion or of the fire chamber and the operation of the apparatus or of the gun. These measurements are transmitted with the aid of the lines 218, 219 and 220 to the controller 215. The latter, depending on instructions given for these characteristic magnitudes, determines the operating parameters of the secondary jets so as to maintain the characteristic magnitudes at their set point values and, with the aid of the line 221, transmits these parameters to the members for controlling the apparatus/the gun.

The apparatus according to the invention advantageously comprises means for controlling the forces of the secondary jet(s), preferably means for controlling the ratio of the pulses of the primary jet and of the secondary jet(s).

This ratio is a function of the ratio of the section of the passageway of the primary jet and of the sections of the secondary pipes, of the ratio of the flow rates in the secondary pipes to the flow rate of the resultant jet and of the ratio of the densities of the fluids of the primary jet and of the secondary jet(s). (In the paragraphs below, when consideration is given to the variation of one of these ratios, the other two are considered constant.)

The more the value of the ratio of the section of the primary jet and of the section of a secondary pipe at the corresponding secondary aperture increases, the greater (at constant respective flow rates) the impact that the corresponding secondary jet has on the primary jet. The user will preferably choose a ratio of sections of between 5 and 50, more preferably between 15 and 30.

The ratio of the flow rate of all the secondary jets to the total flow rate of the resultant jet will typically vary between 0 (no secondary jets) and 0.5 and preferably between 0 and 0.3; more preferably between 0 and 0.15; in the knowledge that the greater this ratio of flow rates, the greater the deviation and/or the aperture of the resultant jet will be.

The ratio of the density of each fluid forming the secondary jets to the density of the fluid of the primary jet makes it possible to control the impact of the secondary jets. The smaller the value of this ratio, the greater will be the effect of the secondary jet on the primary jet, at constant flow rate. For practical reasons, the user will often use the same fluid in the secondary jets and in the primary jet (the ratio equal to unity). To increase (at a constant mass flow rate) the effects of the secondary jets, the user will use a fluid with a smaller density than that of the fluid in the primary jet. The nature of the fluid in the secondary jets will be chosen according to the intended application. It is possible to use for example, to control the deviation of an air jet, a mixture of air and helium (of lesser density) or to increase the driving of the combustion products in a flame whose fuel is propane, control the main jet of fuel and/or oxidant with a secondary jet of water vapor. In general, the ratio of the densities of the densest fluid to the least dense fluid may vary between 1 and 20, preferably between 1 and 10, more preferably between 1 and 5.

The geometry of the section of the passageway of the primary jet and/or of the secondary pipes may have various shapes and notably circular, square, rectangular, triangular, oblong, multilobe, etc. shapes.

The geometry of these injection sections influences the development of the instabilities of the resultant jet. For example, a jet coming out of an injector of triangular shape will be more unstable than that originating from an injector of circular shape, this instability promoting the mixture of the resultant jet with the surrounding medium. Similarly, an injector of oblong shape will promote, in a near field of the injector, the symmetrical development of the jet unlike an injector of circular or square shape.

With respect to the physical-chemical properties of the fluid used to produce the secondary jets, they may be chosen to control certain properties of the resultant flow. For example, it is possible to modify the reactivity of a mixture of main fuel (for example natural gas) jets, oxidant (for example air) jets, by the use of oxygen (or another oxidant) and/or hydrogen (or another fuel).

According to one embodiment, the apparatus is a gun (for example for injecting an oxidant such as oxygen into a combustion zone) of which the jet has a variable direction and/or aperture. Naturally, such a gun may also be used for injecting fuel, that is liquid and/or gaseous and/or solid, into a combustion zone, for example a powdered coal gun (gas such as air which propels solid powder such as coal).

The present invention therefore also relates to a method for heating in which such a gun is used for injecting a jet of fuel and/or oxidant with a variable aperture and/or direction into a combustion zone.

If the end of the passageway of the primary jet, just before the point of interaction of the primary and secondary jets, is furnished with a nozzle comprising a convergent/divergent (also called a de Laval nozzle in the literature), it is possible, at the exit of the divergent, to obtain (in a manner known per se in the literature) a primary fluid jet and a resultant jet, for example a jet of oxygen, that is supersonic, which will then be able to have a variable direction (optionally of variable aperture but usually losing its supersonic speed, which makes it possible to alternate the subsonic and supersonic speeds in certain methods). The de Laval nozzle may also be placed on the resultant jet in front of the main outlet aperture.

According to a variant of the method, at least two secondary jets are used in order to obtain a variation in the direction of the resultant jet in at least secant planes in order to sweep at least a portion of a surface, such as the surface of a load.

By using a secondary jet of which the axis is not secant or quasi-secant with the axis of the primary jet, the aperture of the resultant jet above the load may be varied, alone or in combination with a sweep.

Preferably, means for controlling the quantity of movement of the primary jet and/or of the at least one secondary jet are provided.

It should be noted that, although in the foregoing the apparatus and the method have been illustrated above by making reference to a form of application with a single primary jet that is made to interact with one or more secondary jets, it is evident that the present invention also covers such an apparatus for the injection of a multitude of jets of which the aperture and/or the direction are variable and notably the case in which this multitude of jets with a variable aperture and/or direction are produced from a multitude of primary jets, each primary jet interacting with one or more secondary jets.

FIG. 5 illustrates how the invention makes it possible to vary two resultant main jets and how they interact. One possible application is to vary a jet of fuel and a jet of oxidant in a fire chamber in order to change the characteristics of the flame. FIG. 5a shows a main jet of fuel 61 surmounted by a main jet of oxidant 62, in the situation in which neither of these jets is controlled by an interaction with one or more secondary jets. FIG. 5b shows these same jets but in a situation in which the latter are controlled or deviated in opposition (convergent jets). The jet 60 is deviated downward by the secondary jet 62 while the jet 61 is deviated upward by the secondary jet 63, directed upward (contrary to 61).

FIG. 5c shows these same main jets in a situation in which the jets are controlled or deviated in the same direction (upward in the figure): the secondary jets 63 and 65 act upwardly respectively on the main jets 61 and 60, which generates resultant jets both of which are directed upward. These three examples make it possible to obtain flames with very different direction and morphology (length, flattening, etc.). The flame 64 will be very wide in the horizontal midplane of the injectors, while the flame 67 will be greatly deviated upward.

According to the invention, at the point of interaction between the secondary jet and the primary jet, the axis of the secondary jet makes, with the plane perpendicular to the axis of the primary jet, an angle that is less than 90°, and preferably equal to 0°. However, as illustrated in FIGS. 3C and D, for reasons of space requirement, the channels supplying these jets are most frequently substantially parallel. To reorient the secondary flow at the zone of interaction of the two flows, it is possible to attach to the end of an injector with parallel channels an end-piece hereinafter called an injection tip the function of which is to transform the direction of the secondary jet, initially parallel to the primary jet, into a secondary jet impacting the primary jet, the axis of said secondary jet preferably being situated in a plane perpendicular to the axis of the primary jet.

However, the use of the apparatus for very high temperature processes (T for a process>1000° C.) may lead to overheating and damage to the injection tip.

To avoid this type of problem, the user will seek in the design of the injection tip to reduce the front surface of the apparatus subjected to the radiation in the high-temperature enclosure. For this, the user will seek to limit the ratio l/e.

It is also possible to use one of the two solutions illustrated in FIGS. 9 and 10. The first solution (FIG. 9) consists in placing the apparatus 500 in a refractory piece 501 of which the geometry and the relative apparatus/refractory port position will protect the first from too high a radiation. The position or the retraction of the apparatus in the refractory port must be sufficient to protect it from the radiation but must nevertheless not limit the directional amplitude of the injected jet. For this, it is possible to modify the geometry of the refractory port by eliminating a portion of the latter along the dashed line 160 in FIG. 9 at the angle α.

Preferably, the ratio R/d will range from 0.3 to 3, while the angle α will be in the range [0°, 60°].

The second solution consists in fitting a refractory piece of the sleeve type directly to the snout of the apparatus (where the main outlet aperture is situated) as illustrated in FIG. 10. This solution makes it possible to dispense with a complex-geometry refractory port. The dimensions of the sleeve are such that it does not limit the directional amplitude of the injector. This means in particular that the thickness f of the sleeve is slight (less than the diameter of the main jet) or else that the material used to produce this sleeve has a very low thermal conductivity. The user will choose alumina, for example.

FIGS. 6A and B represent the angle of aperture of the resultant jet as a function of the ratio of the flow rate of the secondary jets (actuators) to the flow rate of the primary jet (main jet).

In FIG. 6A, the curves C1 and C2 represent respectively the angle of aperture of the resultant jet as a function of the actuators/main jet flow rate ratio. C& relates to a configuration CONF1 in which the actuators are perpendicular to the main jet and emerge at a distance h from the main outlet aperture and C2 corresponds to a configuration identical to CONF1, but with a distance 2Hh instead of h between the secondary apertures and the main outlet aperture. These two curves show that the aperture of the resultant jet is larger when the impact between the actuators and the main jet is closer to the main outlet aperture.

FIG. 6b also illustrates the changes of angle of aperture of the resultant jet as a function of the ratio of the flow rates of the actuators and of the main jet: the curve C3 corresponds to the configuration CONF3 with actuators impacting the main jet at 90° (that is to say on a plane perpendicular to the axis of the main jet: θ=0°) at a distance 2Hh from the main outlet aperture (similar to CONF2), while the curve C4 corresponds to the configuration CONF4 which is identical to CONF3, except for the angle of incidence a of the actuators which is 45° relative to the axis of the main jet (that is to say the angle θ between the axis of the actuators and the plane perpendicular to the axis of the main jet=90°−α=45°). Note that, when the actuator jets are perpendicular to the main jet (CONF3: θ=0°), all other things being equal, a larger jet aperture is obtained than when the angle of incidence α of the actuator jets is smaller (in this instance 45°) (CONF4: θ=45°).

FIG. 7 represents the angle of deviation (in degrees) as a function of the ratio of the flow rate of the actuator jets and the flow rate of the main jet, expressed as a percentage. FIG. 7 shows four curves, all other things being equal, for which the flow rate of the main jet is respectively 200 l/min, 150 l/min, 100 l/min and 50 l/min. Note that these four curves are virtually indistinguishable, which clearly shows that the deviation of the main jet is not a function of the flow rate.

FIG. 8 represents a curve of the angle of aperture of the resultant jet as a function of the ratio of the force of the jets.

This curve shows all of the experimental data obtained for the control of the aperture of a jet. The angle of aperture measured is entered as a function of the physical parameter J which is the ratio of the specific forces of the actuator jets and the main jet. This ratio is written as the product of the ratio of the densities (actuator fluid on main fluid) and of the ratio of the square of the speed of the actuator jets and of the square of the speed of the main jet. The main fluid is the same for all the experiments, while different fluids have been used for the actuators. These fluids differ mainly by their density (from the highest density to the lowest: CO2, air, air helium mixture). It is observed that all the experimental points (irrespective of the flow rates and the fluids used) fall into a straight line. This shows that the physical parameter which controls the aperture of the jet is indeed the ratio of the specific forces defined above. The invention also relates to the use of an apparatus/a gun according to the invention to inject a resultant fluid jet the aperture and/or the direction of which are variable, said resultant jet being able for example to include oxygen and/or nitrogen and/or argon and/or carbon dioxide and/or hydrogen. The resultant jet may in particular be a gaseous jet, or else a gaseous jet comprising an atomized liquid and/or solid particles carried along by gas.

The apparatus may notably be used to inject a fluid jet comprising a fuel and/or an oxidant, for example to supply the combustion in a furnace.

The invention is notably useful for injecting a supercritical or supersonic fluid jet.

The invention may also apply to items of food or industrial cryogenics apparatus in which jets of cryogenic liquid (for example liquid nitrogen) are injected, each jet, thanks to the invention and the use of one of more actuator jets, being able to sweep a surface (for example “spray” a whole surface of products to be frozen thanks to a single jet nozzle that can be varied (direction-shape) etc).

The method and the technology of the present invention may be used for the injection, for example, of nitrogen in order to render certain reactors or processes inert. Specifically, a combination of injectors with variable direction or rotational effect (aperture of the jet) makes it possible to more rapidly homogenize the atmosphere of a reactor, for example by increasing its drive in the jets of inert gas, or by promoting the delivery of nitrogen to the sensitive locations thanks to the directional effects.

The invention may also apply to the filling of pressurized gas bottles: the use of composite materials for pressurized storage, for example hydrogen, in lightweight tanks, limits the speed of filling because of the risk of hot spots.

The flow inside the bottle is organized into a jet along the axis of the bottle with an expansion at the entrance of the bottle, then a zone downstream (the bottom of the bottle) where the gases slow down and are compressed (therefore heat up) and two recirculation zones on each side where the hot gases are carried along the walls before being carried into the central jet. The use of an injection with variable aperture, during the filling of the bottle, makes it possible to reverse the latter situation. Specifically, the injection of a jet with very considerable rotational effect makes it possible to generate a flow inside the bottle where the cold gases cooled by the expansion at the entrance of the bottle will travel along the walls of the bottle before being compressed when they reach the bottom of the bottle and to return to the center of the latter along the axis of the latter. The alternating of these two situations during filling makes it possible to limit the temperature of the bottle and to remain in a risk-free temperature range including for high filling speeds.

Another application of the invention is gas quenching: the directional capability of the injectors according to the invention makes it possible to homogenize the temperature in parts that have a complex shape and high heat-resistance.

1-28. (canceled)

29. An apparatus for injecting a fluid jet resulting from an interaction between a primary fluid jet and at least one secondary fluid jet, the apparatus comprising:
a passageway for bringing the primary jet to a main outlet aperture;
at least one secondary pipe for the injection of a corresponding secondary jet and leading into the passageway via a corresponding secondary aperture situated upstream of the main aperture, wherein:
the at least one secondary pipe is positioned relative to the passageway so that, at the point of interaction between the corresponding secondary jet and the primary jet, the angle θ between the axis of the corresponding secondary jet and the plane perpendicular to the axis of the primary jet is less than or equal to 0° and less than 90°, preferably from 0° to 80°, yet more preferably from 0° to 45°; and
the at least one corresponding secondary aperture is spaced from the main aperture by a distance L that is less than or equal to ten times the square root of the section s of the main aperture, preferably L≦5*√s, yet more preferably L≦3*√s; and
a secondary jet force regulator adapted to regulate a force of each corresponding secondary jet to allow said apparatus to vary a direction and/or aperture of the resultant fluid jet by changing the force of at least one corresponding secondary jet.

30. The apparatus of claim 29, wherein the regulation means control the ratio between the force of each corresponding secondary jet and the force of the primary jet.

31. The apparatus of claim 29, comprising at least one secondary pipe positioned relative to the passageway so that the axes of the primary jet and of the corresponding secondary jet at the corresponding secondary aperture are secant or quasi-secant in order to be able to vary the angle between the axis of the resultant fluid jet and the axis of the primary jet upstream of the corresponding secondary aperture.

32. The apparatus of claim 31, comprising at least two secondary pipes positioned relative to the passageway so that the two corresponding secondary apertures are situated in one and the same plane perpendicular to the axis of the primary jet and so that, at these two corresponding secondary apertures, the axes of the corresponding secondary jets are secant or quasi-secant with the axis of the primary jet.

33. The apparatus of claim 32, wherein the two corresponding secondary apertures are situated in one and the same plane perpendicular to the axis of the primary jet and on either side of this axis of the primary jet.

34. The apparatus of claim 32, wherein, at the two corresponding secondary apertures, the plane defined by the axis of the primary jet and one of the two corresponding secondary apertures is perpendicular to the plane defined by the axis of the primary jet and the other of the two corresponding secondary apertures.

35. The apparatus of claim 32, comprising at least four secondary pipes positioned relative to the passageway so that the four corresponding secondary apertures are situated on one and the same cross section of the passageway; so that, at these four secondary apertures the axes of the corresponding secondary jets are secant or quasi-secant with the axis of the primary jet; two of the corresponding secondary apertures defining a first plane with the axis of the primary jet along a first plane and being situated on either side of this axis, the other two corresponding secondary apertures defining a second plane with the axis of the primary jet and being situated on either side of this axis.

36. The apparatus of claim 29, wherein at least one secondary pipe is positioned relative to the passageway so that, at the corresponding secondary aperture, the axis of the corresponding secondary jet is not in substance coplanar with the axis of the primary jet in order to be able to generate, maintain or strengthen a rotation of the resultant jet about its axis.

37. The apparatus of claim 36, comprising at least two secondary pipes positioned relative to the passageway so that the axes of the corresponding secondary jets are not in substance coplanar with the axis of the primary jet and that the corresponding secondary jets are oriented in one and the same direction of rotation about the axis of the primary jet.

38. The apparatus of claim 37, wherein the two secondary apertures corresponding to the two secondary pipes are situated on one and the same cross section of the passageway.

39. The apparatus of claim 37, wherein the two corresponding secondary apertures are situated on either side of the axis of the primary jet.

40. The apparatus of claim 37, wherein, at the two corresponding secondary apertures, the plane defined by the axis of the primary jet and one of the two corresponding secondary apertures is perpendicular to the plane defined by the axis of the primary jet and the other of the two corresponding secondary apertures.

41. The apparatus of claim 37, comprising at least four secondary pipes positioned relative to the passageway so that the four corresponding secondary apertures are situated on one and the same cross section of the passageway and so that, at these four corresponding secondary apertures, the axes of the corresponding secondary jets are not in substance coplanar with the axis of the primary jet, two of these corresponding secondary apertures defining a first plane with the axis of the primary jet and being situated on either side of this axis, the other two corresponding secondary apertures defining a second plane with the axis of the primary jet and also being situated on either side of this axis, the four corresponding secondary jets being oriented in one and the same direction of orientation about the axis of the primary jet.

42. The apparatus of claim 29, wherein at least one secondary pipe is positioned relative to the passageway so that, at the corresponding secondary aperture, the secondary pipe has a thickness e and a height l, the height l being greater than or equal to 0.5 times the thickness e, preferably between 0.5 H e and 5 H e.

43. The apparatus of claim 29, wherein at least a portion of the passageway consists of a primary pipe for the injection of the primary jet and leading to a primary aperture.

44. The apparatus of claim 43, wherein the primary aperture is positioned upstream of the main aperture.

45. The apparatus of claim 44, comprising at least one secondary aperture adjacent to the primary aperture and situated between the main aperture and the primary aperture.

46. The apparatus of claim 29, comprising means for controlling the ratio of the forces of the main fluid jet and of the secondary fluid jet.

47. The apparatus of claim 29, comprising a block of material in which at least a portion of the passageway is situated, the main aperture being situated on one of the faces or surfaces of the block.

48. The apparatus of claim 29, comprising means for controlling the forces of the primary and/or secondary jets.

49. The apparatus of claim 29, characterized in that it also comprises means for controlling the fluid flow rate of the primary and/or secondary jets.

50. The apparatus of claim 29, characterized in that the ratio between the section of the passageway at a secondary aperture and the section of the secondary aperture is between 5 and 50, preferably between 15 and 30.

51. The apparatus of claim 29, comprising a de Laval nozzle furnished with a convergent/divergent system placed on the passageway upstream or downstream of the at least one secondary aperture.

52. A method for injecting a fluid jet resulting from an interaction between a primary fluid jet and at least one secondary fluid jet, comprising the steps of:
providing the apparatus of claim 29; and
varying a direction and/or aperture of the resultant fluid jet by changing the force of at least one corresponding secondary jet with the secondary jet force regulator.

53. The method of claim 52, wherein the resultant fluid jet comprises a fuel and/or an oxidant.

54. The method of claim 52, wherein the resultant fluid jet is a supercritical fluid jet.

55. The method of claim 52, further comprising the step of injecting the resultant fluid jet into a process selected from the group consisting of a combustion process, a food cryogenics process, a gas bottles filling process, and a gaseous quenching process.

56. The method of claim 52, wherein the resultant fluid jet comprises a liquid and/or solid particles.
